(19) United States
(12) Patent Application Publication
(10) Pub. No.: US 2014/0055064 A1
(43) Pub. Date: Feb. 27, 2014

(54) Systems and Methods for Controlling Motor Speeds

(71) Applicant: Chee-Kiong Ng, Acton, MA (US)

(72) Inventor: Chee-Kiong Ng, Acton, MA (US)

(73) Assignee: Allegro Microsystems, Inc., Worcester, MA (US)

(21) Appl. No.: 13/595,430

(22) Filed: Aug. 27, 2012

(51) Int. Cl. H02P 6/06

(52) U.S. Cl. 318/400.11

(57) ABSTRACT

Electronic circuits for controlling the speed of a motor include a receiving node coupled to receive a speed command signal representative of a desired final speed of the motor. A speed control circuit applies a selected amount of power to a motor to allow a speed of the motor to approach a predetermined final speed, where the selected amount of power provided is based on the desired final speed of the motor. A signal represents the speed of the motor and a feedback circuit uses the signal to regulate the speed of the motor by phase-locking the speed of the motor to the speed command signal once the speed of the motor falls within a predetermined threshold of the final speed. Methods for controlling the speed of a motor are also disclosed.

### FIELD

This invention relates to electric motor control circuits and, more particularly, to an electric motor control circuit that can accelerate a motor to a desired speed for subsequent speed regulation.

### BACKGROUND

Circuits to precisely control, drive, and regulate brushless DC (BLDC) electric motors are required in many applications. Conventionally, when a BLDC motor is idle, a control circuit will accelerate the motor until a frequency lock can be achieved. Once the frequency is locked, the control circuit will then initiate a phase lock for more precise control over the motor's speed.

Some known electric motor drive circuits are described in U.S. Pat. No. 7,590,334, issued Sep. 15, 2009, U.S. Pat. No. 7,747,146, issued Jun. 29, 2010, and U.S. patent application Ser. No. 13/271,723, filed Oct. 12, 2011 and entitled “Electronic Circuit And Method Generating Electric Motor Drive Signals Having Phase Advances In Accordance With A User Selected Relationship Between Rotational Speed Of An Electric Motor And The Phase Advances,” each of which is assigned to the assignee of the present invention.

Certain applications can benefit if the motor is able to quickly ramp up to and become stable at its final speed. For example, many laser and ink-jet printers enter a sleep mode when not in use where motors in the printers are idle or powered off. When a print job is received, the motors must accelerate to their final speed, and the motor controller must stabilize the speed of the motor, before printing can begin. Reducing the time it takes the motor to reach and become stable at its final speed can reduce the amount of time required to being printing.

In view of the above, it would be desirable to provide a motor control circuit and associated method that can reduce the amount of time required for a motor to reach and become stable at its final speed. It would also be desirable to provide a motor control circuit that can drive the motor at a rotational speed synchronized with an external frequency signal received by the motor control circuit.

### SUMMARY

In an embodiment, a method of controlling the speed of a motor includes receiving a signal representative of a desired final speed of the motor. A selected amount of power is applied to the motor in order to change the speed of the motor. The selected amount of power is based on the desired final speed of the motor. The power applied to the motor is maintained to allow the speed of the motor to continually approach the desired final speed. The speed of the motor is detected and, once the speed increases to within a threshold of the desired final speed, the selected amount of power is decoupled from the motor the speed of the motor is phase locked so as to regulate the motor at the final speed.

The method may also include, prior to applying the selected amount of power, providing a fixed amount of power to the motor so as to maximize acceleration of the motor toward the desired final speed. The fixed amount of power may be the maximum power available.

In an embodiment, an electronic circuit for controlling the speed of a motor includes a receiving node coupled to receive a speed command signal that represents a desired final speed of the motor. The circuit also includes a speed control circuit that applies a selected amount of power to the motor to allow a speed of the motor to approach a predetermined final speed, where the selected amount of power is based on the desired final speed of the motor. A signal representing the speed of the motor is received. A feedback circuit uses the signal to regulate the speed of the motor by phase-locking the speed of the motor to the speed command signal once the speed of the motor falls within a predetermined threshold of the final speed.

The electronic circuit may also include a look-up function that associates the amount of power to be applied to the motor by the control circuit with desired final speeds of the motor.

In an embodiment, the speed control circuit is configured to apply a fixed power to the motor to allow the speed of the motor to accelerate at a maximum rate toward the final speed. The fixed power may be a maximum power available.

### BRIEF DESCRIPTION OF THE DRAWINGS

The foregoing features of the invention, as well as the invention itself may be more fully understood from the following detailed description of the drawings, in which:

FIG. 1 is a block diagram showing an exemplary motor control circuit having speed controller block for controlling the speed of a motor;

FIG. 2 is a flowchart showing a process for applying power levels to a motor and regulating the speed of the motor;

FIG. 3 is a graph showing frequency count response of a motor versus applied power;

FIG. 4 is a graph showing frequency response of a motor versus applied power;

FIG. 5 is a look-up table showing desired final speeds of a motor and the power level to be applied to the motor;

FIG. 6A, FIG. 6B, and FIG. 6B are look-up tables showing desired final speeds of a motor and the power level to be applied to the motor; and

FIG. 7 is a table showing the time between application of power to the motor and speed lock regulation of the motor under varying circumstances.

Like numbers in the drawings denote like elements. Connectors within circuit or block diagrams may represent single wires, buses, or other types of connections between blocks. A single connector line should not be construed to limit the type of connection to a single wire.

The figures, including the flowcharts and block diagrams, are provided for exemplary purposes and are not intended to limit the scope of this disclosure. Although the figures depict diagrams and flowcharts with particular numbers of blocks connected in particular arrangements or sequences, these are examples only. Other arrangements and sequences are within the scope of this disclosure.

### DETAILED DESCRIPTION

Before describing the present invention, some introductory concepts and terminology are explained. As used herein, the term “magnetic field sensing element” is used to describe a variety of electronic elements that can sense a magnetic field. The magnetic field sensing element can be, but is not limited to, a Hall effect element, a magnetoresistance element, a magnetotransistor, or a receiver that can receive back electromotive force (Back-EMF) signals from a motor.

As known in the art, a spinning motor can act like a generator. The electromotive force produced by the spinning motor may be referred to as back-EMF. Signals produced by this back-EMF can be measured to determine the position and speed of the motor. For example, the magnitude of the back-EMF signals may be directly proportional to the speed of the motor. In some instances, these signals can be measured without the need for an external sensor. In these so-called “sensorless systems,” the back-EMF signals may be fed back directly from the motor into an input of the motor driver circuit.

As is known, different types of Hall effect elements can also be used to measure position and speed of the motor. These Hall effect elements include, for example, a planar Hall element, a vertical Hall element, and a Circular Vertical Hall (CVH) element. As is also known, there are different types of magnetoresistance elements, for example, a semiconductor magnetoresistance element such as Indium Antimonide (InSb), a giant magnetoresistance (GMR) element, an anisotropic magnetoresistance element (AMR), a tunneling magnetoresistance (TMR) element, and a magnetic tunnel junction (MTJ). The magnetic field sensing element may be a single element or, alternatively, may include two or more magnetic field sensing elements arranged in various configurations, e.g., a half bridge or full (Wheatstone) bridge. Depending on the device type and other application requirements, the magnetic field sensing element may be a device made of a type IV semiconductor material such as Silicon (Si) or Germanium (Ge), or a type III-V semiconductor material like Gallium-Arsenide (GaAs) or an Indium compound, e.g., Indium-Antimonide (InSb).

As used herein, the term “signal” is used to describe an electronic characteristic, analog or digital, that can change over time. In contrast, as used herein, the term “value” is used to describe a digital electronic value that tends to be static, or that tends to change from time to time. However the terms signal and value can be used interchangeably.

As used herein, the term “demand” or “demand signal” is used to describe any electronic signal, analog or digital, that controls an amount of power applied to a motor. For example, as the demand signal changes, the amount of power applied to a motor may also change.

As used herein, the terms “software” and “firmware” may refer to computer readable instructions, stored in a volatile or non-volatile computer readable storage medium (such as a hard drive or memory). The computer readable instructions, when executed by a processor or circuit, may cause the processor or circuit to perform operations and/or processes described below. The terms “software” and “firmware” may also refer to other types of instructions such as microcode, machine-code, scripts, or any type of computer readable instruction set that can be stored in a computer readable storage medium and executed by a processor or circuit

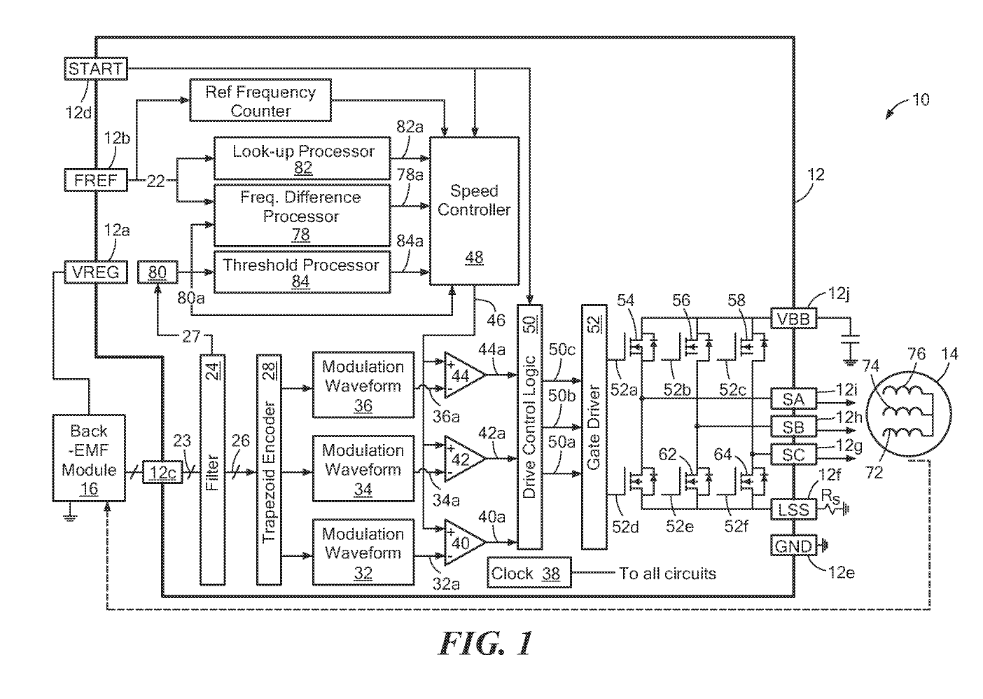

Referring to FIG. 1, a motor drive arrangement 10 is shown that includes an exemplary electronic circuit 12 coupled to an electric motor 14 and to a Back-EMF module 16. In some embodiments, the electronic circuit 12 may be a silicon chip. The chip may include a silicon wafer having integrated circuitry that implements, in whole or in part, the systems and methods described below. The wafer may be encapsulated by a package and one or more pins 12a-12j that interface with external circuitry. In other embodiments, the electronic circuit 12 may be implemented as software, as other types of circuitry (e.g. FPGA, discrete components, etc), or as a combination of software and circuitry. Additionally, the systems and methods described may be implemented in whole or in part by an electronic circuit, or may be implemented in whole or in part by a processor executing computer readable instructions, such as microcode, firmware, software, or the like. In the latter embodiment, the instructions may be stored in a computer-readable volatile or non-volatile memory and, when executed by the processor, may cause the processor to perform certain operations for controlling the speed of the motor 14.

The embodiment shown in FIG. 1 displays the back-EMF circuitry as a separate module 16. However, one skilled in the art will recognize that, in embodiments of the technology, the back-EMF module 16 may not be a separate module. In other words, the electronic circuit 12 may be a so-called “sensorless” motor control that does not utilize a separate sensor or module to detect the position and speed of the motor 14. In such embodiments of the technology, back-EMF signals from windings of the motor 14 may be coupled directly from the motor 14 to input pins of the electronic circuit 12. In such systems, the back-EMF module 16 may be a receiver or other circuit that is integrated into the electronic circuit 12. In other embodiments, circuitry to receive the back-EMF from the motor 14 may be incorporated into the electronic circuit 12, into the motor 14, or into a separate module.

In embodiments of the system, back-EMF module 16 may be replaced by other sensors or circuits that can measure the speed or position of the motor 14 including, but not limited to, an array of Hall sensors, one or more resolvers, or any other device or sensor that can measure the position, frequency, or speed of the motor 14. For simplicity, block 16 will simply be referred to as back-EMF module 16.

Pin 12a, a regulated voltage pin (VREG), is coupled to receive a regulated voltage 20 from outside of the electronic circuit 12. The regulated voltage 20, or alternatively, a regulated current, is provided to the back-EMF module 16. The regulated voltage 20 may also provide power to some or all of the circuitry within the electronic circuit 12.

Pin 12b, a frequency reference pin (FREF), is coupled to receive frequency reference signal 22 from outside of the electronic circuit 12. If for example, the electronic circuit 12 is installed in a printer, the frequency reference signal 22 may be supplied by circuitry within the printer and may represent a desired final speed of the motor 14. At different times, the printer may require different motor speeds. For example, a high quality printout mode of the printer may require relatively slow motor speeds while a draft printout mode may require relatively fast motor speeds. Accordingly, the frequency reference signal 22 may be a variable signal, and may change according to requirements of the external circuitry.

The frequency reference signal 22 can be an analog signal, a digital signal, a square wave, a sine wave, a pulse-width modulated signal, or any type of signal that can represent a desired motor speed. In an embodiment, the frequency reference signal 22 may be a sine or square wave oscillating at a frequency that represents the desired motor speed. As described in greater detail below, functions of the electronic circuit 12 can be synchronized with the frequency reference signal 22.

Pins 12c are shown as a bus coupled to receive input signals from the back-EMF module 16. These signals may be a counter-electromotive force produced by the windings of the motor 14. In such an arrangement, the back-EMF signals received by pins 12c may indicate the position and frequency or speed of the motor 14.

Although shown as a single pin 12c, the electronic circuit 12 may include multiple input pins to receive signals from the back-EMF module 16. If the motor 14 includes three windings, for example, then electronic circuit 12 may have three input pins, one for each winding. In embodiments, there may be one pin for each motor winding, to receive back-EMF signals from the individual windings. In other embodiments, the input pins may be coupled to receive back-EMF signals from a subset of the motor windings. For example, if the motor has six windings, there may be an input pin coupled to every other winding, for a total of three input pins. Because back-EMF signals are produced by windings of the motor 14, the back-EMF signals received by the input pins 12c can be used to determine the position and speed of the motor 14.

Pin 12d, a start pin (START), is coupled to receive a control signal from outside of the electronic circuit 12. The control signal can start and stop the functions of the electronic circuit 12, and therefore, start and stop the electric the motor 14.

Pin 12e, a ground pin (GND), provides a power supply ground for the electronic circuit 12.

Pin 12f, a lower supply pin (LSS), is coupled to receive a lower power supply voltage from outside of the electronic circuit 12.

Pins 12g, 12h, 12i, motor drive signal pins (SC, SB, SA, respectively), are coupled to provide PWM drive signals 80, 82, and 84 to the electric the motor 14.

Pin 12j, an upper supply pin (VDD), is coupled to receive an upper power supply voltage from outside of the electronic circuit 12.

If the back-EMF module 16 is replaced with a Hall sensor, Hall effect elements within the Hall sensor may be positioned to sense magnetic fields, and, in particular, varying magnetic fields, of magnets within the motor 14 as a shaft of the motor 14 rotates. In one particular embodiment, the Hall sensor may include three Hall effect elements that can be disposed at positions relative to the motor 14 that are one hundred twenty degrees apart about an axis of rotation of the shaft of the electric motor. In another embodiment, the Hall sensor may include six Hall effect elements disposed at positions relative to the motor 14 that are sixty degrees apart about the axis of rotation. In the case where there are six pole pairs, the frequency of the signals from the Hall elements (in Hz) will be about ten (10) times greater than the rotations per minute of the motor 14. In general, the Hall effect elements may be arranged so that the frequency of signals from a Hall effect sensor is proportional to the speed of the motor 14. This known proportionality can be used to translate the frequency of the signals from the Hall sensor into a signal representing the speed of the motor 14. Accordingly, any desired number of Hall elements may be used.

In various embodiments of the technology, the back-EMF module 16 generates position signals 23 which are received by a digital filter 24. The position signals 23 are generally analog signals, and each is representative of an angle of rotation of the shaft of the motor 14.

Conversion to digital signals is not shown in FIG. 1, but it is presumed that the position signals 23 are either converted to digital signals before they reach digital filter 24 or within the digital filter 24. The digital filter 24 is configured to generate filtered signals 26 and 27, which are representative of the position signals 23. The filtered signals 26 and 27 can be, for example, multi-bit digital signals. The filtered signals 26 are also representative of the angle of rotation of the shaft of the electric the motor 14.

A so-called trapezoid encoder 28 is coupled to receive the signals 26. A trapezoid encoder will be understood to be a form of pattern generator and is also referred to as a pattern generator herein.

The trapezoid encoder 28 is configured to generate output signals 30a, 30b, and 30c (also referred to herein as pattern signals), which can be single bit square wave signals. In some embodiments, the three output signals 30a, 30b, 30c represent drive signals for the three coils of the motor 14 and have phases one hundred twenty degrees apart.

The electronic circuit 12 further includes a plurality of modulation waveform generators 32, 36, and 38, each coupled to receive a respective one of the output signals 30a, 30b, and 30c from the trapezoid encoder 28. Operation of the modulation waveform generators 32, 34, and 36 is described more fully in U.S. patent application Ser. No. 13/278,461, filed Oct. 21, 2011, which is incorporated here by reference in its entirety. Let it suffice here to say that the modulation waveform generators are configured to generate respective output signals 32a, 34a, 36a, which are functioned signals, for example, triangle or sawtooth wave signals.

The electronic circuit 12 can also include a plurality of comparators 40, 42, 44, each coupled to receive one of the output signals 34a, 36a, 38a from modulation waveform generators 32, 34, 36. Each one of the plurality of the comparators 40, 42, 44 is also coupled to receive a demand signal 46 from speed controller 48. The speed controller 48 can change the demand signal 46 in order to change the amount of power applied to the motor 14. A discussion of a demand signal is included in U.S. patent application Ser. No. 13/278,461, filed Oct. 21, 2011, which is incorporated here by reference in its entirety. Let it suffice here to say that the speed controller 48 can modify the amount of power applied to the motor 14 by changing the value of the demand signal 46.

In other embodiments, each one of the comparators 40, 42, 44 can be coupled to receive a different respective threshold value, and the amount of power applied to the motor 14 can be controlled in different ways by speed controller 48. In embodiments, the speed controller 48 may include a PID controller for controlling demand signal 46 and regulating the speed of the motor 14.

The plurality of the comparators 40, 42, 44 is configured to compare respective ones of the output signals 34a, 36a, 38a from the plurality of the modulation waveform generators 34, 36, 38 with the demand signal 46 to generate a respective plurality of output signals 40a, 42a, 44a, as pulse width modulated (PWM) signals.

Digital control logic 50 is coupled to receive the pulse width modulated signals 40a, 42a, 44a and configured to generate preliminary drive signals 50a, 50b, 50c.

A gate driver circuit 52 is coupled to receive the preliminary drive signals 50a, 50b, 50c and configured to generate gate drive signals 52a-52f. For clarity, only two of the gate drive signals are shown to be coupled, but the other couplings should be apparent.

Three high side field effect transistors (FETs) 54, 56, 58 are coupled to receive the gate drive signals 52a, 52b, 52c, respectively, and three low side FETs 60, 62, 64 are coupled to receive the gate drive signals 52f, 52e, 52d. The gate drive signals 52a-52f cause the FETs 54-64 to operate in saturation with pulse width modulation, and thus, consume only a small amount of power.

The arrangement of the FETs 54-64 is configured to generate three drive signals 66, 68, 70, which are coupled to ends of respective ones of windings 72, 74, 76 within the electric the motor 14. Other ends of the windings 72, 74, 76 can be coupled together.

A clock circuit 38 provides a clock signal 38a to some or all portions and circuits within electronic circuit 12.

The electronic circuit 12 can also include a frequency difference processor 78 coupled to receive the frequency signal 80a from the frequency counter 80, and the frequency reference signal 22 from outside of the electronic circuit 12. The frequency counter 80 may convert the filtered signal 27 into a frequency signal 80a that represents the frequency of filtered signal 27, and thus the speed of the motor 14. In an embodiment, the frequency difference processor is configured to generate a difference signal 78a, which represents a frequency difference, a phase difference, or both, between the frequency reference signal 22 (e.g. the desired final speed of the motor 14) and the frequency signal 80a (e.g. the actual speed of the motor 14).

In an embodiment, the electronic circuit 12 may also include a look-up processor 82 and a threshold processor 84. The look-up processor 82 may be coupled to receive the frequency reference signal 22 and provide a look-up signal 82a based on the frequency reference signal 22. The look-up signal 82a may be a demand signal, i.e. a signal representing the amount of power to be applied to motor 14. For example, if the frequency reference signal 22 represents a desired final speed of the motor 14, the demand signal 82a may represent an optimally selected power level to be applied to the motor 14 in order to allow the motor 14 to accelerate to the desired final speed. Applying the selected power level can allow the electronic circuit 12 to subsequently stabilize and regulate the speed of the motor 14 at the desired speed. The look-up signal 82a may be an analog voltage level, a digital value, or any other type of signal that can represent a selected amount of power. For example, the look-up signal 82a may be a demand signal that speed controller 48 can apply directly to the motor 14. In other embodiments, the look-up signal 82a may represent a selected amount of power to be applied to the motor 14, and speed controller 48 can use the look-up signal 82a to compute an appropriate demand signal 46 that will provide the appropriate selected amount of power.

In an embodiment, the look-up processor 82 may include a look-up table that can receive the frequency reference signal 22 and provide the look-up signal 82a that corresponds to the frequency reference signal 22. The look-up processor 82 may also include other algorithmic circuits or software for providing or calculating look-up signal 82a, including, but not limited to: a computational circuit, firmware, software, etc.

The electronic circuit 12 may also include threshold processor 84 coupled to receive the frequency signal 80a and provide a threshold signal 84a. The threshold signal 84a may represent whether frequency signal 80a is within a desired frequency threshold. The frequency threshold may be a fixed threshold (such as a frequency of about 1.2 kHz). In this case, the threshold signal 84a may indicate whether the frequency signal 80a is above or below the fixed threshold. The frequency threshold may also represent a variable threshold. For example, the frequency threshold may be set so that threshold signal 84a indicates whether frequency signal 80a is within about a +/−50% window of frequency signal 22, a +/−10% window of frequency signal 22, a +/−19% window of frequency signal 22, or any other frequency window. Although the numbers 1.2 kHz and +/−50% have been used in the example above, one skilled in the art will recognize that the thresholds can be set to any desired value. Additionally, the frequency windows need not be symmetrical about the frequency signal 22. For example, the lower threshold of the frequency window may be 10% while the upper threshold of the frequency window may be 45%. Any appropriate symmetrical or non-symmetrical frequency window may be used.

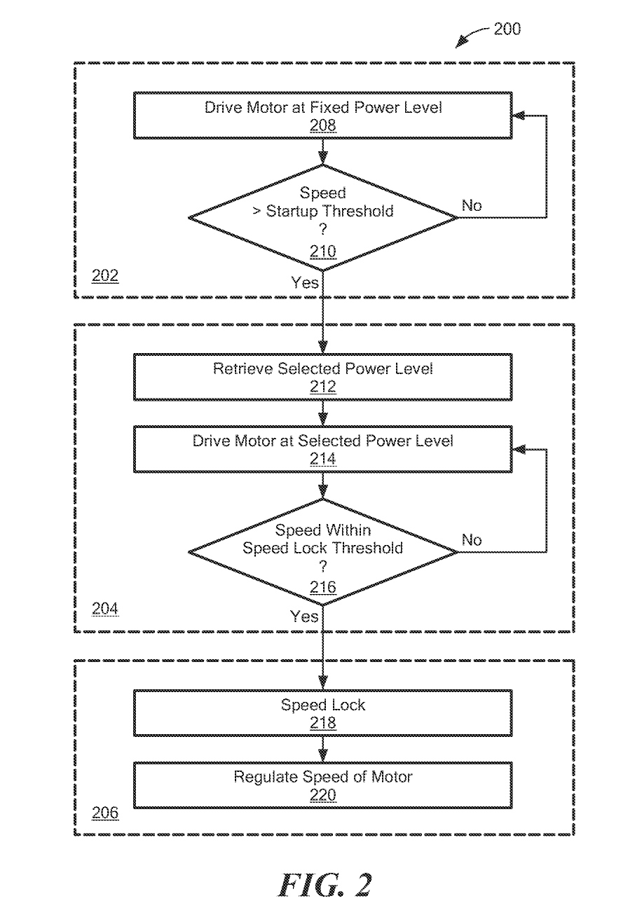

Using the threshold signal 84a, the look-up signal 82a, and the frequency difference signal 78a, speed controller 48 may provide a demand signal 46 to control the speed of the motor 14. In embodiments, based on the state of the motor 14, the speed controller 48 may control the speed of the motor 14 according to different control modes which are discussed in connection with FIG. 2.

Referring now to FIG. 2, a flowchart is shown that illustrates a process 200 for controlling the speed of the motor 14 according to various control modes. For simplicity, the following example describes process 200 as though implemented by the speed controller 48 shown in FIG. 1. However, the process 200 may also be implemented, in whole or in part, by other portions of electronic circuit 12, by other circuits, by computer readable instructions such as firmware, software, microcode, or the like, or by a combination of circuitry and computer readable instructions.

The process 200 may control the speed of the motor 14 according to a first control mode 202, a second control mode 204, and a third control mode 206. In the first control mode 202, the speed controller 48 may apply a fixed power level to the motor 14, as shown by box 208. In an embodiment, the fixed power level may be a maximum power, i.e. a full power available from electronic circuit 14 for driving the motor 14. In some embodiments, electronic circuit 12 will provide a 100% duty cycle signal to the motor 14 in order to provide the maximum available power. This will allow motor 14 to quickly accelerate so that the speed of the motor 14 approaches the desired final speed as quickly as possible. In other embodiments, the fixed power level may be any desired power level that allows the speed of motor 14 to accelerate toward the desired final speed provided by frequency reference signal 22. (See FIG. 1). If the motor 14 is already turning faster than the desired speed, the fixed power level may be a zero-power or relatively lower power to allow the motor 14 to quickly decelerate toward the desired final speed. The fixed power level may also be any intermediate power level desired.

While the fixed power level is applied, electronic circuit may check whether the present speed of the motor is greater than a startup threshold, as shown by decision block 210. As long as the present speed of the motor 14 is less than the startup threshold, the speed controller 48 may continue to drive the motor 14 at the fixed power level.

In an embodiment, the speed controller 48 can receive the startup threshold from threshold processor 84 via threshold signal 84a. (See FIG. 1). The startup threshold may define a range of speed within which the fixed power level will be applied to the motor 14. For example, in an embodiment, the startup threshold may be preset to about 1.2 kHz or 12,000 RPM, as discussed above. In this case, the electronic circuit 12 may apply the fixed power level to motor 14 as long as the speed of the motor 14 is less than or equal to 1.2 kHz or 12,000 RPM. Of course, these values are provided merely as examples—startup threshold can be preset to any other desired level. In another embodiment, the startup threshold can be dynamically changed during operation of the electronic circuit 12. Also, although shown as an upper threshold, the startup threshold can also be a lower threshold so that the speed controller 48 can apply the fixed power to the motor 14 so long as the speed of the motor 14 is above the lower threshold.

When the speed of the motor 14 becomes equal to or greater than the startup threshold, the speed controller 48 may drive the motor 14 according to the second mode 204. In the second mode 204, the power level applied to the motor 14 may be a selected power level supplied by the lookup processor 82. Accordingly, the speed controller 48 may retrieve the selected power level from the lookup processor 82, as shown by box 212, and drive the motor 14 at the selected power level, as shown by box 214.

The selected power level may vary, and may be based upon the desired final speed of the motor 14, i.e. based upon reference frequency signal 22, for example. As will be discussed below, lookup processor 82 may provide the selected power level based on a lookup table, based on calculations performed by the lookup processor 82, or based on other means of generating or providing the selected power level.

The selected power level may be an intermediate power level that slows the rate of acceleration of the motor 14 as the speed of the motor 14 approaches the desired final speed. For example, in an embodiment, the selected power level may be a lower power level than the fixed power level. The lower, selected power level can slow the rate of acceleration of the motor 14 as the speed of the motor 14 approaches the desired final speed. Slowing the rate of acceleration in this way can allow the motor 14 to be subsequently regulated via speed lock or phase lock regulation (as described in connection with mode 206 below) without the need for an intermediate frequency lock. For example, a traditional lock circuit may first establish commutation, then approximate a frequency lock, then engage a phase and frequency lock on the motor 14. In other embodiments, if desired, the selected power level provided by the lookup processor 82 and applied to motor 14 during the second mode 204 can increase the rate of acceleration or keep the rate of acceleration the same.

As the speed of the motor 14 continues to accelerate toward the desired final speed while driven by the selected power level, the speed controller 48 may check whether the speed of the motor 14 is within a speed lock threshold, as shown by decision block 216. If the speed is not within the speed lock threshold, speed controller 48 may continue to drive the motor 14 at the selected power level in block 708.

The speed lock threshold may be a preset threshold that allows electronic circuit 12 to engage a speed lock or phase lock on the motor 14. In an embodiment, the speed lock threshold may be based upon the desired final speed, and may be a window set to about +/−5% of the desired final speed. However, the speed lock threshold can be preset or dynamically set to any appropriate value.

Once the speed of the motor 14 accelerates into the speed lock threshold window, the speed controller 48 may control the speed of the motor 14 according to a third mode 206. In the third mode 206, the speed controller 48 may regulate the speed of the motor at the desired speed. As shown by block 218, the speed controller 48 may initiate speed lock. In an embodiment, the speed lock may be a phase-lock control scheme that can precisely and accurately control the speed of the motor 14. Once the speed lock is initiated, the speed controller 48 can then regulate the speed of the motor at the desired final speed, as shown by block 220.

By using a selected power level to drive the motor 14 as the speed of the motor 14 approaches the desired final speed, speed controller 48 can initiate a speed lock or phase lock once the speed of the motor 14 enters the speed lock threshold without the need to first engage a frequency lock of the motor 14. A speed lock may occur when the difference between the speed of the motor and the desired final speed is within a particular tolerance so that the speed of the motor can be locked and controlled. In other words, by accelerating the motor 14 according to the selected power level as the speed of the motor 14 approaches the speed-lock threshold, and by speed-locking or phase-locking the speed of the motor once the speed enters the speed-lock threshold, speed controller 48 can immediately speed-lock or phase-lock the speed of the motor 14 and can skip the time consuming step of frequency locking the speed of the motor 14 prior to phase-locking. This can reduce the amount of time required for speed controller 48 to lock the speed of the motor 14 and accurately regulate the motor 14 at the desired final speed.

As described above, the mode 202, 204, or 206 used by the speed controller 48 to control the speed of the motor 14 may depend upon the present speed of the motor. To summarize, assume, for example, that the motor 14 is idle when frequency signal 22 is set by external circuitry to a desired final speed of the motor 14. Once frequency signal 22 is set, speed controller 48 may begin driving the motor 14 at a fixed power level according to mode 202, then drive the motor 14 at a selected power level according to mode 204 to reduce the rate of acceleration of motor 14, then lock the speed of the motor 14 and regulate the motor at the desired final speed according to mode 206. In embodiments, the quick acceleration in modes 202 and 204, and the phase-locking and regulating in mode 206 without the need to lock the frequency of motor 14, can reduce the time required to ramp the speed of the motor 14 up and regulate the motor 14 at the desired final speed.

In some embodiments, speed controller 48 may include a proportional-integral-derivative (“PID”) controller (not shown) to regulate the speed of the motor 14. In such embodiments, the integrator input of the PID controller can be set to a constant value during modes 202 and/or 204. This can allow speed controller 48 to control the speed of the motor 14 in an open-loop arrangement during phases 202 and 204. In other words, setting the integrator input to a constant value allows the PID controller to accelerate the motor 14 without feedback from the motor 14 slowing the rate of acceleration as the speed of motor 14 approaches the final speed. The proportional and derivative inputs of the PID can also be set to constant values during phases 202 and 204.

As speed controller 48 begins to regulate the speed of motor 14 according to mode 206, the integrator input of the PID controller can receive information about the speed of the motor 14 from the back-EMF module 16 so that the PID controller can phase-lock the speed of motor 14 and regulate the speed in a feedback loop arrangement.

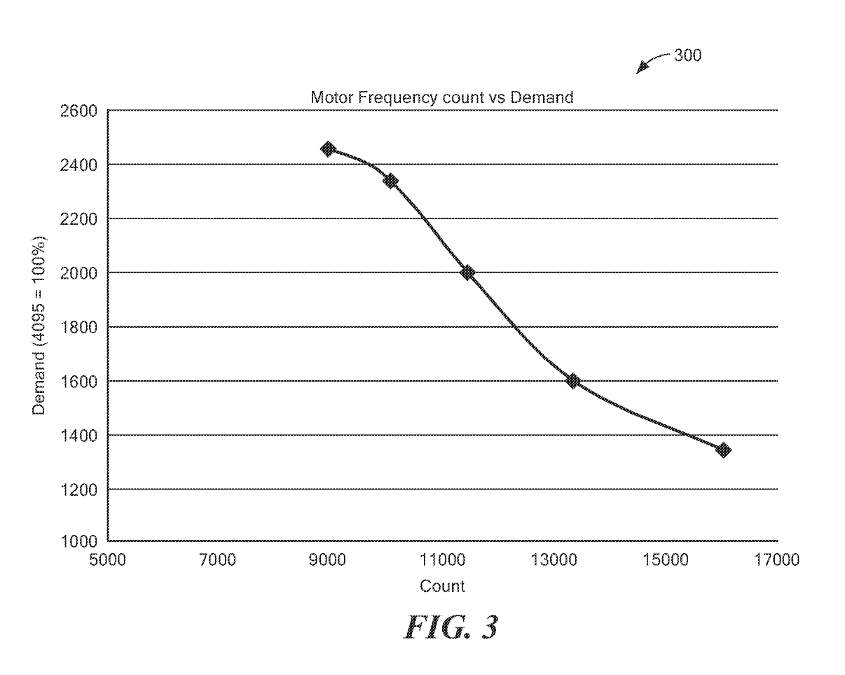

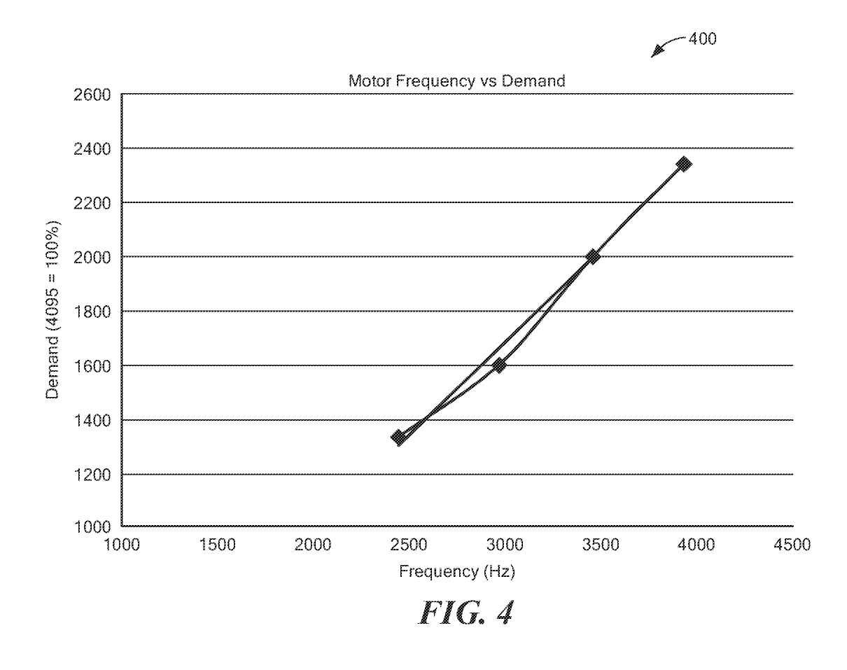

Referring now to FIG. 3 and FIG. 4, the selected power level provided by may be based upon a characterization of the motor to be regulated. FIG. 3 shows a graph 300 of the power applied to the motor 14 (on the vertical axis) versus the frequency count of the motor 14 (on the horizontal axis) that can be used to characterize the motor 14. The frequency count may correspond to a number of clock edges or counts that occur between the edges of frequency signal 23. (See FIG. 1). In other words, the frequency count on the horizontal axis of FIG. 3 is proportional to the period of the motor 14 at a given applied power level. Accordingly, as shown in FIG. 3, as the power applied to the motor 14 increases, the period decreases.

FIG. 4 shows a graph 400 that of the frequency of the motor 14 (on the horizontal axis) versus the power applied to the motor 14 (on the vertical axis). As is known in the art, frequency and period are inversely proportional. Therefore, in an embodiment, the frequency of the motor 14 shown in graph 400 may be derived from the frequency count shown in graph 300. Therefore, the frequency on the horizontal axis of FIG. 4 may be proportional to motor speed.

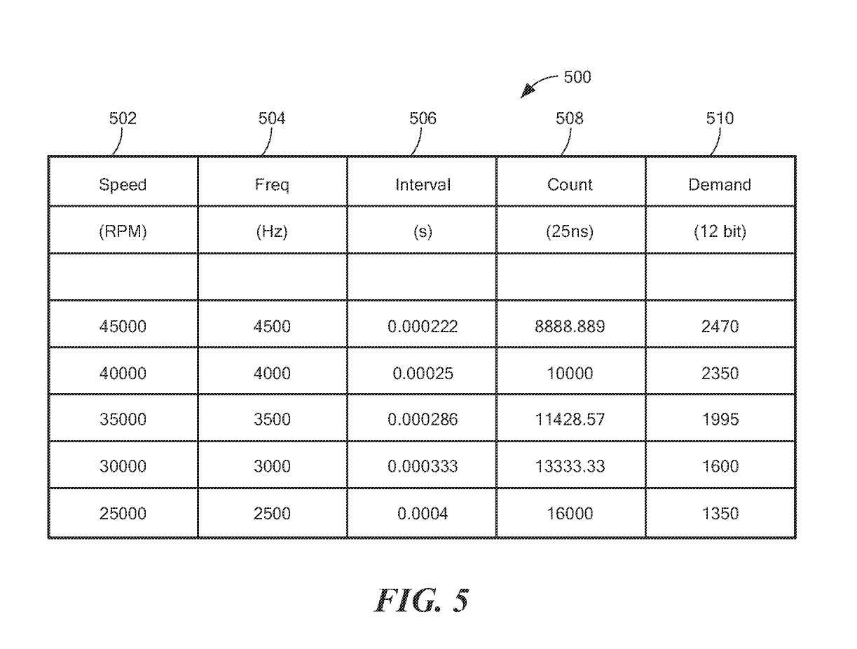

Once the motor 14 has been characterized, the values in FIG. 3 and FIG. 4 can be used to populate a look-up table, such as the look-up table 500 in FIG. 5.

Referring now to FIG. 5, in an embodiment, a look-up table 500 may be implemented by the look-up processor 82 so that, when the look-up processor 82 receives a desired final speed, the look-up processor 82 can provide demand signal 82a corresponding to the desired final speed to the speed controller 48. The look-up table 500 may be populated by running the motor 14 in an open loop configuration at different demand levels (i.e. different input voltages or input PWM values) and recording the motor speed. These values, when characterized for a particular motor (or type of motor) and stored in the look-up table 500, can act to tailor the operation of the electronic circuit 12 for the particular motor 14 that is being driven, or the particular application in which the motor 14 is being used. Accordingly, in an embodiment, the look-up table 500 and/or the look-up processor 82 may be programmable. Programming the values can take place during a manufacturing process, dynamically during operation of the electronic circuit 12, or at any other time.

The look-up table 500 is shown with five columns. Column 502 contains a desired final speed of the motor 14. Column 504 contains a desired final frequency of the motor 14 (i.e. a frequency generated by Back-EMF module 16) that corresponds to the desired final speed. Column 506 contains the interval or period. The value in column 506 may be the inverse of the frequency (i.e. 1/Frequency). Column 508 contains a count representing the number of master clock counts that occur within the interval. In other words, the count in column 508 may be: (interval)/(master clock interval). In an embodiment, the master clock may be the clock signal produced by the clock circuit 38 (See FIG. 1).

Column 510 includes a demand value. In an embodiment, the demand value may be a 12-bit number. However, the demand value can be stored in the look-up table 500 as any type of data. The demand value corresponds to a selected power level to be applied to the motor 14. Once received by speed controller 48, the demand value can inform speed controller 48 as to the amount of power to be applied to the motor 14. Speed controller 48 can then provide an appropriate demand signal 46 so that the selected amount of power is applied to the motor 14.

The look-up table 500 contains five rows populated with particular values for a particular type of motor. One skilled in the art will recognize that the numbers populating the look-up table 500 are not limiting, and that the look-up table may be populated with other values for other types of motors as appropriate.

If the desired final speed of the motor 14 appears as an entry in look-up table 500, look-up value circuit 82 can simply provide the appropriate demand value to speed controller 48. For example, if frequency reference signal 22 is 4500 Hz, which is an entry in table 500, look-up value circuit 82 can provide the corresponding demand value of 2470.

However, if the desired final speed of the motor 14 does not appear in look-up table 500, look-up value circuit 82 can calculate the demand value from entries within look-up table 500. For example, if frequency reference signal 22 is 4250 Hz, which is not an entry in table 500, look-up value circuit 82 can extrapolate the demand value from the other entries in table 500. In an embodiment, look-up value circuit 82 can use any technique to extrapolate the demand value for frequencies that do not appear in look-up table 500, including curve fitting, linear extrapolation, and the like.

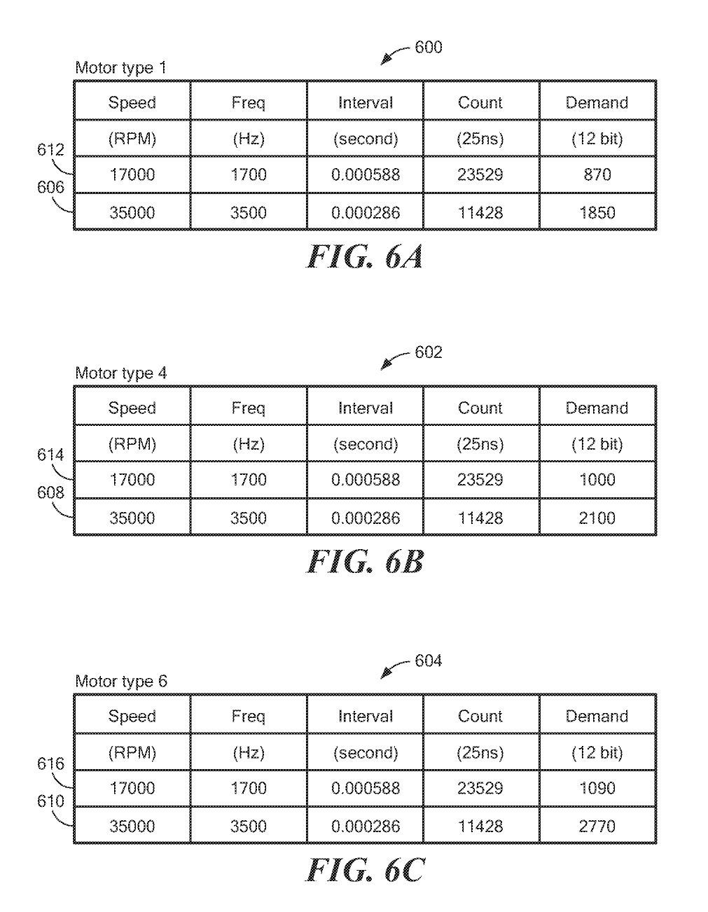

FIG. 6A, FIG. 6B, and FIG. 6C show additional look-up tables 600, 602, and 604, respectively, which can also be used by look-up circuit 82. As shown, each of the look-up tables 600, 602, and 604 may include two columns. The reduced number of rows may require less memory space when the look-up table is stored or implemented by the look-up circuit 82.

If the look-up table has two rows, one of the rows (e.g. row 606, row 608, or row 610) may correspond to a higher speed of the motor 14, and the other row (e.g. row 612, row 614, or row 616) may correspond to a lower speed. In an embodiment, the lower speed in row 612, row 614, or row 616 may be approximately one-half of the higher speed in row 606, row 608, or row 610). However, the lower speed row need not be one-half of the higher speed row so long as the two rows contain different speeds.

If the rows contain different speeds, the two rows may be used to define a linear curve of demand values for the motor 14. Using table 600 as an example, the lower speed row 612, which provides a desired final speed value of 17,000 RPM and a demand value of 870, which may define one point on the linear curve, and the higher speed row 606, which provides a desired final speed value of 35,000 RPM and a demand value of 1850, may define a second point on the linear curve.

The look-up circuit 82 may implement a look-up function that can compute the demand value. In some embodiments, the look-up function can compute the demand value without a look-up table, can retrieve the demand value from a look-up table, or can extrapolate the demand value from entries within a look-up table. For example, the look-up function may include an algorithm that uses a linear curve defined by the look-up table to extrapolate a demand value for any desired final speed of the motor 14. In an embodiment, the look-up circuit 82 may implement an extrapolation algorithm such as:

$$y = \frac{x - x 1}{y 2 - y 1} = \frac{n ( x 2 - x 1 ) - x 1}{y 2 - y 1}$$

where y is the demand value computed by the look-up circuit 82, x is the desired final speed provided by the frequency reference signal 22, (x1, y1) correspond to a (demand value, final speed) pair from one row of the look-up table, and (x2, y2) correspond to a (demand value, final speed) pair from a second row of the look-up table. In an embodiment, the extrapolation algorithm implemented by the look-up circuit 82 can also include features such as searching gradient curve that has either a positive or negative slope, searching up to speed that is twice the value of the higher speed (e.g. the y2 value) from the look-up table, and searching for a value between 0 and the lower speed (e.g. the y1 value) from the look-up table.

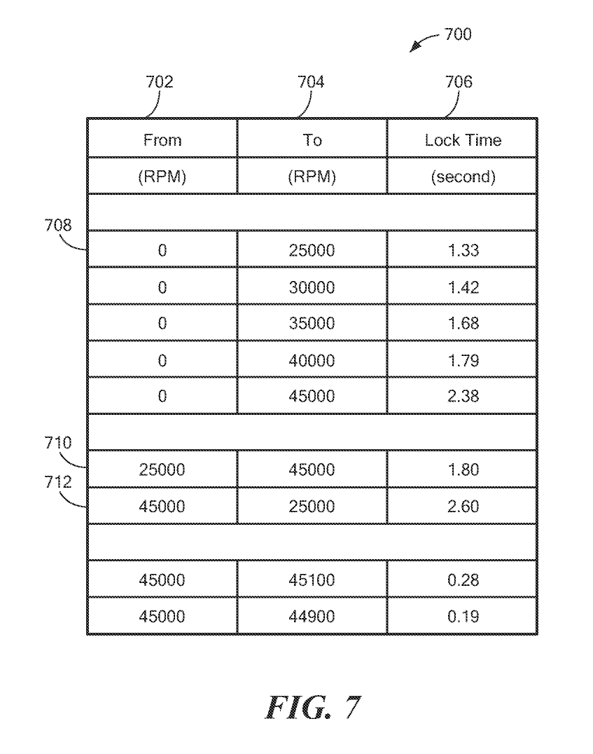

Referring now to FIG. 7, a table 700 includes test results sampled from an electronic circuit 12. Column 702 represents the initial speed of the motor 14, column 704 represents the desired final speed of the motor 14, and column 706 represents the amount of time required for the electronic circuit 12 to accelerate the motor 14 to the desired final speed and initiating a speed-lock or phase-lock for regulating the speed of the motor 14. For example, row 708 shows that with a starting speed of 0 RPM, and a desired final speed of 25,000 RPM, the sample electronic circuit 12 was able to accelerate the motor 14 and lock the speed of the motor 14 for regulation at the desired final speed in about 1.33 seconds. Row 610 shows that with a starting speed of 25,000 RPM, and a desired final speed of 45,000 RPM, the sample electronic circuit 12 was able to accelerate the motor 14 and lock the speed of the motor 14 for regulation at the desired final speed in about 1.8 seconds. Row 612 shows that with a starting speed of 45,000 RPM, and a desired final speed of 35,000 RPM, the sample electronic circuit 12 was able to decelerate the motor 14 and lock the speed of the motor 14 for regulation at the desired final speed in about 2.6 seconds.

The data in table 700 represent sample results for one test run of one particular motor. One skilled in the art will recognize that additional test runs and other types of motors may produce varying data.

The electronic circuit 12 can reduce the amount of time required for a motor to reach and maintain a desired final speed. For example, by engaging the speed lock described above, the electronic circuit 12 can establish regulation over the motor 14 by providing a predetermined power level to the motor 14, then providing a power level obtained from the look-up table 500 to the motor 14, then engaging a non-accumulative phase-frequency-lock to regulate the motor. In contrast, a traditional lock circuit may, for example, first establish communication with the motor 14, then approximate an accumulative frequency lock with the motor 14, then engage an accumulative phase-frequency-lock with the motor 14.

In some embodiments, the electronic circuit 12 can establish regulation over the speed of the motor 14 in less time than a traditional lock circuit. In many cases, the electronic circuit 12 can establish regulation in less than half the time it takes a traditional lock circuit to establish regulation. This can provide advantages in various fields. For example, if the motor 14 is installed in the paper path of a printer, electronic circuit 12 can reduce the amount of time required to ramp the motor 14 up to its final speed so that the printer can begin printing. If the motor 14 is installed in a pump, for example, electronic circuit 12 can similarly reduce the amount of time required for the pump to reach its desired final speed. In general, electronic circuit 12 can be used to reduce the time required to start any type of electric motor.

Having described various embodiments, which serve to illustrate various concepts, structures and techniques, which are the subject of this patent, it will now become apparent to those of ordinary skill in the art that other embodiments incorporating these concepts, structures and techniques may be used. Accordingly, it is submitted that that scope of the patent should not be limited to the described embodiments but rather should be limited only by the spirit and scope of the following claims.

What is claimed is:

1. A method of controlling speed of a motor comprising:
receiving a signal representative of a desired final speed of the motor,
applying a selected amount of power to the motor in order to change the speed of the motor, the selected amount of power based on the desired final speed of the motor;
maintaining the power applied to the motor to allow a speed of the motor to continually approach the desired final speed while the power is applied; and
once the detected speed increases to within a threshold of the desired final speed, decoupling the selected amount of power from the motor and phase-locking the speed of the motor to the signal representing the desired final speed so as to regulate the motor at the final speed.

2. The method of claim 1, further comprising identifying the selected amount of power from a look-up function that associates amounts of power to be applied to the motor with desired final speeds of the motor.

3. The method of claim 2, wherein identifying the selected amount of power from a look-up function includes reading one or more entries from a look-up table comprising predetermined amounts of power and desired final speeds based on a characterization of the motor that is to be controlled.

4. The method of claim 3 further comprising extrapolating, by the look-up function, the desired final speed from the one or more entries in the look-up table.

5. The method of claim 1, wherein the step of applying comprises applying, to the motor, a pulse-width modulated signal with a selected duty cycle, the duty cycle selected in accordance with the selected amount of power.

6. The method of claim 1, further comprising, prior to the step of applying, providing a fixed amount of power to the motor so as to maximize acceleration of the motor toward the desired final speed.

7. The method of claim 6, wherein the fixed amount of power is a maximum available power.

8. The method of claim 6, further comprising removing the fixed amount of power and applying the selected amount of power once the speed reaches a predetermined speed.

9. The method of claim 1, wherein the threshold is a window that includes a lower limit about 50% lower than the desired final speed and/or an upper limit about 50% higher than the final speed.

10. The method of claim 1, wherein the step of phase locking comprises utilizing a PID circuit to phase-lock the motor.

11. The method of claim 1, wherein the step of applying the selected amount of power to the motor includes providing a constant value to an integrator/accumulator input of a PID circuit that controls the speed of the motor.

12. The method of claim 1, wherein the step of applying the selected amount of power includes applying the power to an idle motor.

13. The method of claim 1, wherein the step of applying the selected amount of power includes applying the selected amount of power to the motor while the motor is rotating at a speed lower than the desired final speed.

14. An electronic circuit for controlling the speed of a motor comprising:
a receiving node coupled to receive a speed command signal representative of a desired final speed of the motor;
a speed control circuit that applies a selected amount of power to the motor to allow a speed of the motor to approach a predetermined final speed, where the selected amount of power provided is based on the desired final speed of the motor, and
a feedback circuit coupled to receive a signal representing the speed of the motor, and uses the signal to regulate the speed of the motor by phase-locking the speed of the motor to the speed command signal once the speed of the motor falls within a predetermined threshold of the final speed.

15. The electronic circuit of claim 14, further comprising a look-up function circuit that associates the amount of power to be applied to the motor by the control circuit with desired final speeds of the motor.

16. The electronic circuit of claim 15, wherein the lookup function circuit comprises a look-up table stored in a programmable memory.

17. The electronic circuit of claim 14, wherein the feedback circuit includes a PID for regulating the speed of the motor.

18. The electronic circuit of claim 17, wherein a constant value is coupled to an integrator/accumulator input of the PID while the selected amount of power is applied to the motor.

19. The electronic circuit of claim 17, wherein the output of the signal is coupled to an integrator/accumulator input of the PID in order to phase-lock and regulate the motor.

20. The electronic circuit of claim 1, wherein the speed control circuit is configured to apply a maximum power to the motor to allow the speed of the motor to accelerate at a maximum rate toward the final speed.

21. The electronic circuit of claim 20, wherein the speed control circuit is further configured to provide the maximum power until the motor reaches a predetermined speed, and to provide the predetermined amount of power subsequent to the motor reaching the predetermined speed.

22. The electronic circuit of claim 21, wherein the predetermined speed is about 12,000 RPM.

23. The electronic circuit of claim 14, wherein the predetermined threshold includes a lower limit that is 50% lower than the desired final speed and/or an upper limit that is 50% higher than the desired final speed.

24. The electronic circuit of claim 14, wherein the signal is one of:
a back-EMF signal generated by windings of the motor,
an output of a Hall effect sensor, and
an output of a resolver.
